(19) United States
(12) Patent Application Publication
(10) Pub. No.: US 2013/0342394 A1
(43) Pub. Date: Dec. 26, 2013

(54) APPARATUS AND SYSTEM FOR TRACKING PACKAGING INCLUDING BAIT PACKAGING

(71) Applicant: EyeSpy Security Ltd., Sidney (CA)

(72) Inventors: Michael James Leslie, Sidney (CA); Jerome Allan Reilander, Sidney (CA)

(73) Assignee: EyeSpy Security Ltd.

(21) Appl. No.: 13/925,053

(22) Filed: Jun. 24, 2013

Related U.S. Application Data
(60) Provisional application No. 61/663,278, filed on Jun. 22, 2012.

(51) Int. Cl. G01S 19/16; G01S 19/48

(52) U.S. Cl. CPC G01S 19/16; G01S 19/48
USPC 342/357.31; 342/357.54

(57) ABSTRACT

A combined GPS and GSM cellular tracking solution for tracking small, high-value assets, including: a packaging component; induction charging; transmission of information (preferably through a local cellular network); and an internet-based database and website with which users can remotely track goods.

### CROSS REFERENCE TO RELATED APPLICATIONS

This application claims the benefit of U.S. Provisional Patent Application No. 61/663,278, filed 22 Jun. 2012.

### FIELD OF THE INVENTION

The present invention relates to product security, namely the tracking and recovery of high-value products.

### BACKGROUND OF THE INVENTION

Theft of high-value goods, from storage, while in transit or in so-called “smash and grabs” when a high-value item is on display, is a common problem.

In the past couple of decades there has been ongoing development with respect to apparatuses and systems for tracking and locating goods and people, and with respect to electronics generally, for example, as described in: U.S. Pat. No. 5,917,433, Keillor, et al., Jun. 29, 1999, Asset monitoring system and associated method; U.S. Pat. No. 6,275,143, Stobbe, Aug. 14, 2001, Security device having wireless energy transmission; U.S. Pat. No. 6,441,778, Durst, et al., Aug. 27, 2002, Pet locator; U.S. Pat. No. 6,509,867, McGibney, Jan. 21, 2003, Article tracking device; U.S. Pat. No. 6,510,380, Curatolo, et al., Jan. 21, 2003, Security and tracking system; U.S. Pat. No. 6,606,556, Curatolo, et al., Aug. 12, 2003, Security and tracking system; U.S. Pat. No. 6,628,232, Hynes, et al., Sep. 30, 2003, GPS tracker; U.S. Pat. No. 6,657,587, Mohan, Dec. 2, 2003, Tracking system using miniaturized concealable communications module; U.S. Pat. No. 6,675,091, Navab, Jan. 6, 2004, System and method for tracking, locating, and guiding within buildings; U.S. Pat. No. 6,889,135, Curatolo, et al., May 3, 2005, Security and tracking system; U.S. Pat. No. 6,920,391, Daubert, et al., Jul. 19, 2005, High resolution tracking of mobile assets; U.S. Pat. No. 7,026,789, Bozzone, et al., Apr. 11, 2006, Charging system for electronic devices; U.S. Pat. No. 7,142,979, Shonk, Nov. 28, 2006, Method of triggering the transmission of data from a mobile asset; U.S. Pat. No. 7,313,476, Nichols, et al., Dec. 25, 2007, Method and system for controlling a valuable movable item; U.S. Pat. No. 7,319,412, Coppinger, et al., Jan. 15, 2008, Asset monitoring and tracking system; U.S. Pat. No. 7,366,522, Thomas, Apr. 29, 2008, Method and system for location tracking; U.S. Pat. No. 7,411,512, Domeier, Aug. 12, 2008, Tracking the geographic location of an animal; U.S. Pat. No. 7,415,355, Janky, et al., Aug. 19, 2008, Method and system for controlling an electronic device; U.S. Pat. No. 7,548,040, Lee, et al., Jun. 16, 2009, Wireless battery charging of electronic devices such as wireless headsets/headphones; U.S. Pat. No. 7,627,427, Nichols, et al., Dec. 1, 2009, Method and system for controlling a valuable movable item; U.S. Pat. No. 7,647,164, Reeves, Jan. 12, 2010, Web service for mobile device tracking; U.S. Pat. No. 7,761,228, Ichimura, Jul. 20, 2010, Mobile object location providing device and mobile object location providing system; U.S. Pat. No. 7,872,445, Hui, Jan. 18, 2011, Rechargeable battery powered portable electronic device; U.S. Pat. No. 7,948,208, Partovi, et al., May 24, 2011, Power source, charging system, and inductive receiver for mobile devices; U.S. Pat. No. 7,961,081, Tomlienovic, et al., Jun. 14, 2011, Anti-theft system and method; U.S. Pat. No. 8,026,693, Burley, Sep. 27, 2011, Induction charger for portable battery-powered devices; U.S. Pat. No. 8,054,037, Nagatsuka, et al., Nov. 8, 2011, Electronic device; U.S. Pat. No. 8,159,182, Kato, et al., Apr. 17, 2012, Contactless power transferring coil unit, mobile terminal, power transmitting apparatus, and contactless power transferring system; U.S. Pat. No. 8,169,185, Partovi, et al., May 1, 2012, System and method for inductive charging of portable devices; U.S. No. D368,430, Herzog, Apr. 2, 1996, Molded plastic jewelry box; U.S. No. RE40,642, Harrison, et al., Feb. 17, 2009, Reduced-power GPS-based system for tracking multiple objects from a central location; and US 2011/01486727, Grimm, 23 Jun. 2011, Tracking Unit.

### SUMMARY OF THE INVENTION

In one aspect, the invention provides a combined GPS/GSM cellular tracking system for tracking small, high-value assets such as precious metals, precious stones, jewelry and other luxury items. There are three major features of the invention: a packaging component; transmission of information (preferably through a local cellular network); and an internet-based database and website with which users can remotely track goods.

In another aspect, the invention provides a tracking apparatus for use in monitoring the location of high-value items and recovering stolen items, the apparatus including: a bait package containing; a tracking module, including a microprocessor and computer memory, and enabled for connection with a cellular network and enabled for reception of Global Positioning System (GPS) information; an induction receiver electrically connected to the tracking module; and a battery electrically connected to the tracking module; and an induction transmitter configured for inducing a charging current in the induction receiver, when the induction transmitter and induction receiver are sufficiently proximate one to the other; wherein, in use, the bait package may be located so as to bring the induction transmitter and induction receiver into sufficient proximity to induce a charging current in the induction receiver, so as to maintain a desirable state of charge in the battery.

Sufficient proximity to induce a charging current in the induction receiver may include a spaced apart relationship as between the bait package and the induction transmitter, whereby in use a material may be interposed between the bait package and the induction transmitter, so as to conceal or disguise the induction transmitter.

The enablement for reception of GPS information may include assisted GPS (AGPS) functionality whereby GPS satellite acquisition information may be obtained from a cellular network. The tracking module may be enabled for Wi-Fi communication or for Bluetooth communication, or for both. The tracking module may include an RFID chip.

The apparatus may include a sound emitter powered by the battery and controlled by the microprocessor. The apparatus may include a sensor component connected to the microprocessor, the sensor component being one or more of: an accelerometer for detecting and measuring movement; a temperature sensor for detecting unsafe charging temperatures; a microphone for capturing sound in the vicinity of the bait package; and a contact switch for indicating removal of the bait package from a surface.

The bait package may have an appearance consistent with a display box for a high-value item. The high-value item may be one of jewelry, time pieces, coins or precious metals.

In another aspect, the present invention provides a system for monitoring the location of high-value items and recovering stolen items, the system including: at least one bait package as described above; and a computer server connected to the Internet and configured: for receiving information from and transmitting information to the bait package via a cellular network, and for providing a user with access, via a user computing device connected to the Internet, to information received from the bait package and for enabling the user to send instructions to the bait package.

Location information transmitted from the bait package may be encrypted; the decryption password may be set by the user by way of a message from a cellular network device to the bait package via a cellular network; and the decryption of information transmitted from the bait package may occur on the user computing device connected to the Internet, whereby the decryption password is not transmitted by, or stored on, the computer server.

When a triggering event occurs the bait package may send an alarm message to at least one cell phone number provided by the user. The user may determine the triggering event. The user may select between two alternative triggering events, being any detected movement of the bait package, and removal of the bait package from within a defined area.

The tracking module may have three operational modes, being; a sleep mode in which the tracking module is dormant; a wake mode in which the tracking module transmits periodic information updates; and a pursuit mode in which the tracking module transmits functionally continuous information updates. The tracking module may automatically switch from sleep mode to awake mode responsive to any detected movement of the bait package, and the user may instruct the tracking module to switch from sleep mode to awake mode, from awake mode to pursuit mode or sleep mode, and from pursuit mode to awake mode.

The bait package may include a sound emitter powered by the battery and controlled by the microprocessor, and the user may cause the sound emitter to emit sound by an instruction sent via a user computing device connected to the Internet.

The tracking module may be enabled for Wi-Fi communication and may be configured to preferentially utilize Wi-Fi communication over cellular network communication, when Wi-Fi service is available.

The tracking module may be enabled for Bluetooth communication and may be configured for direct communication with a specific Bluetooth enabled device when instructed to do so by the user.

### SUMMARY OF THE DRAWINGS

FIG. 1 is a top-plan schematic representation of a tracking module embodiment of the present invention;

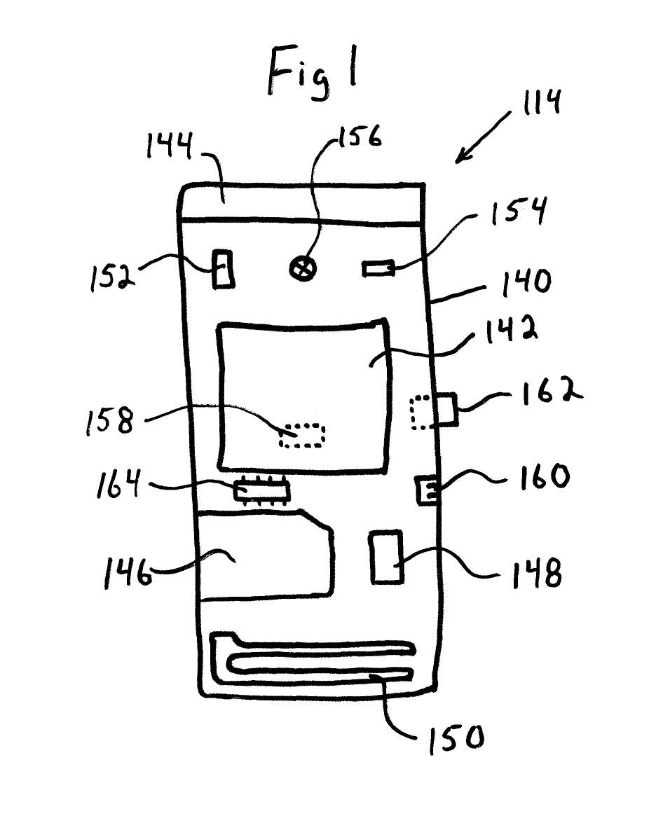

FIG. 2 is a top-plan simplified schematic representation of a tracking module embodiment of the present invention, enabled for Wi-Fi communication.

FIG. 3 is a top-plan simplified schematic representation of a tracking module embodiment of the present invention, enabled for Bluetooth communication.

FIG. 4 is a top-plan simplified schematic representation of a tracking module embodiment of the present invention, having an RFID chip.

FIG. 5 is a quasi-perspective stylized representation of a bait package embodiment and a tracking module, sound emitter, battery and induction receiver coil assembled for installation in the bait package.

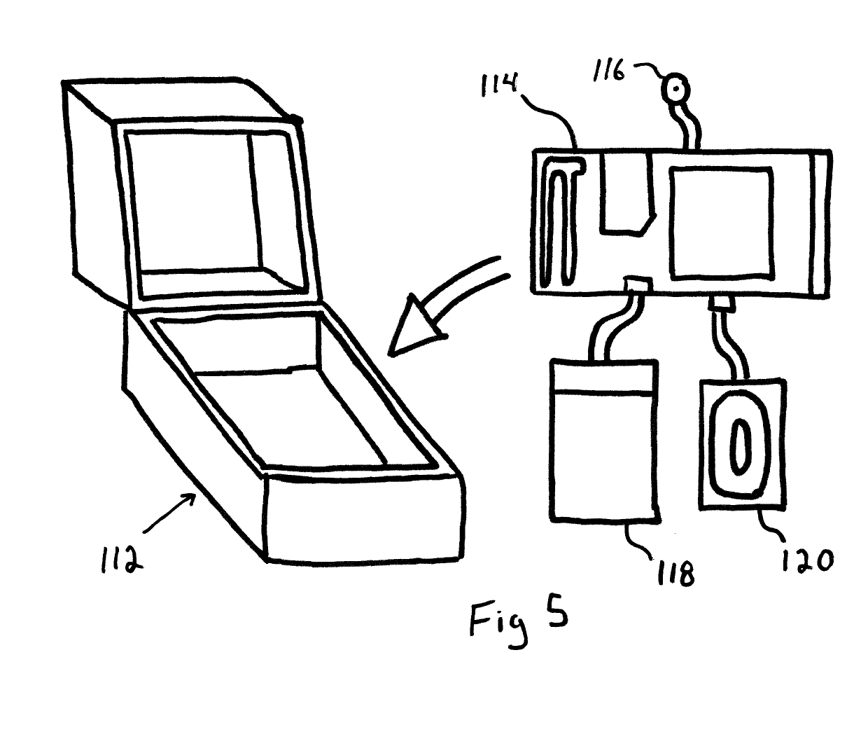

FIG. 6 is a top-plan sectional schematic representation of a bait package embodiment of the present invention showing the tracking module and associated components installed.

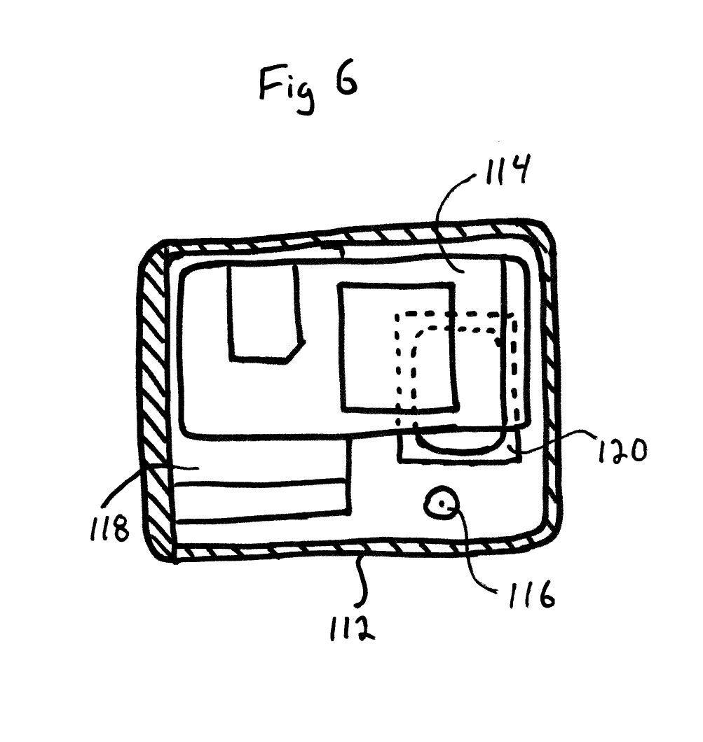

FIG. 7 is a perspective schematic representation of a bait package embodiment of the present invention displaying a ring and resting on an induction transmitter pad.

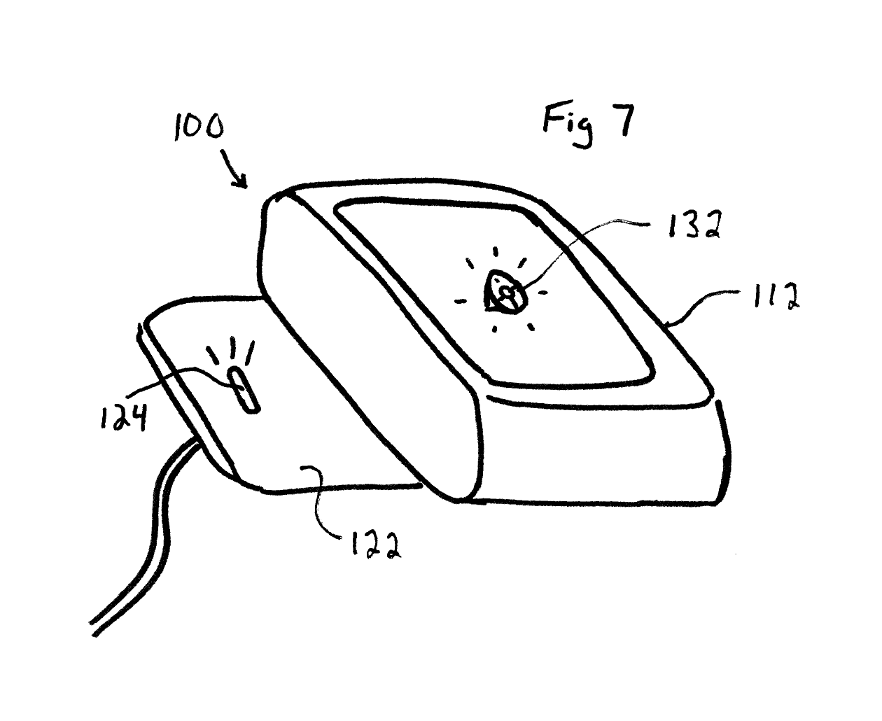

FIG. 8 is a perspective schematic representation of a bait package embodiment of the present invention displaying a necklace and located above a concealed induction transmitter pad.

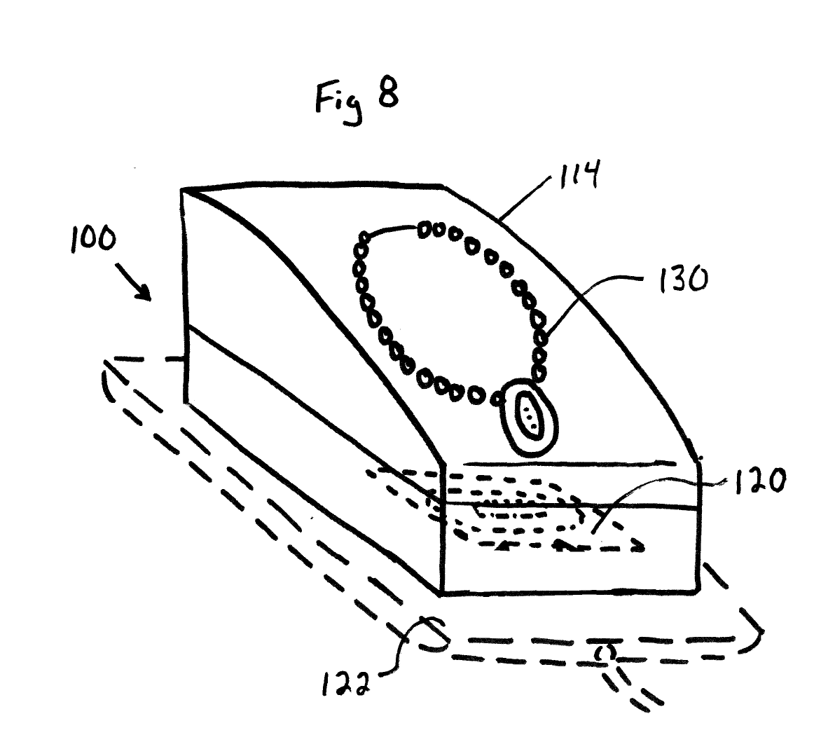

FIG. 9 is a schematic representation of communication pathways and devices associated with bait package embodiments having the tracking module configured for cellular communication, shown with two user computers, two user cellular devices and three bait packages.

FIG. 10 is a schematic representation of communication pathways and devices associated with bait package embodiments having a tracking module configured for cellular and Wi-Fi communication, shown with one user computer, one user cellular device and one bait package.

FIG. 11 is a schematic representation of communication pathways and devices associated with bait package embodiments having a tracking module configured for cellular and Bluetooth communication, shown with one user computer, one user cellular device and one bait package.

FIG. 12 is a schematic representation of communication pathways and devices associated with bait package embodiments having a tracking module configured for cellular communication and having an RFID chip, shown with one user computer, one user cellular device and one bait package.

FIG. 13 is a representation of a tracking page of a user portal feature of a system embodiment of the present invention.

FIG. 14 is a representation of the tracking page of FIG. 13 after the user has clicked on a bait package icon.

FIG. 15 is a representation of an isolation view of the dashboard indicated in FIG. 14.

FIG. 16 is a representation of an isolation view of a Set Alarm Box.

FIG. 17 is a representation of a pursuit mode page indicating two bait packages in pursuit mode.

FIG. 18 is a representation of a user smart phone indicating a mobile app version of the user portal.

### DETAILED DESCRIPTION WITH REFERENCE TO THE DRAWINGS

As shown in the drawings, embodiments of the present invention include a packaging component 100 and a user portal 300.

The packaging component 100 includes a bait package 112 housing a tracking module 114, a sound emitter 116, a battery 118 and an induction receiver coil 120. Associated with the packaging component 100 there is an induction transmitter pad 122 for cooperatively functioning with the induction receiver coil 120.

To ensure suitable GPS and cellular communication performance, the bait package 112 is preferably constructed from non-metallic materials and may include a structural plastic shell, a wooden frame or both. The bait package 112 may be covered with a suitable material such as an attractive leatherette or other fabric.

The bait package 112 preferably resembles a container for high-value goods, such as a diamond display box, ring box, jewelry combo box or watch box. The appearance of the bait package 112 is generally determined by the application and user's needs (for example, a diamond salesperson would use a diamond display box, a jewelry retailer would use a combination of ring and pendant boxes, and a gold buying company would use shipping packages containing miscellaneous gold). The bait package 112 may be customized to match a user's existing display stock.

A bait product (for example, a necklace 130 or a ring 132) may be used in conjunction with the bait package 112. The bait product may be a fake high-value item, for example fake diamonds such as cubic zirconia, fake jewelry or fake coins.

The Xact Trax™ (Xact Technology LLC), is an example of a commercially available module having features comparable to the tracking module 114. The tracking module 114 includes a circuit board 140 and has the following interconnected components: a tracking module microprocessor 142, a cellular antenna, a SIM card slot 146, a GPS receiver 148, a GPS antenna 150, an accelerometer 152, a temperature sensor 154, a microphone 156 a contact switch 158, a charger connection 160, a battery connection 162, a tracking module data storage component 164, and a tracking module microprocessor 160.

The tracking module data storage component 164 is a conventional computer storage device, for example a flash memory. The tracking module microprocessor 142 is a conventional programmable device that accepts digital data as input, processes it according to instructions stored in the tracking module data storage component 164, and provides results as output.

In the embodiments described herein, the tracking module microprocessor 142 provides the functionality of a wireless GSM module, which is a Global System for Mobile Communications module capable of connecting to a cellular network (i.e., through a conventional General Packet Radio Service (GPRS) connection) and sending and receiving information via conventional information transmission services including Short Message Service (SMS), as well as Hypertext Transfer Protocol (HTTP) and Simple Mail Transfer Protocol (SMTP). However, it is understood that the wireless GSM module functionality could instead be provided by a separate component, being a wireless GSM module physically distinct from the microprocessor 142.

The cellular antenna 144 is a conventional such antenna configured to enable connection to a cellular network.

The SIM card slot 146 is a conventional such slot for receiving SIM card, which is a removable card in which is embedded a subscriber identity module or subscriber identification module (SIM), which is an integrated circuit that securely stores the international mobile subscriber identity (IMSI) and the related key used to identify and authenticate subscribers on mobile telephony devices (such as mobile phones and computers). If considered desirable in terms of component size or for other reasons, the SIM card slot 146 (and the associated necessity for a SIM card), could be eliminated by use of soft SIM technology, which is software based reprogrammable SIM.

The GPS receiver 148 and GPS antenna 150 are conventional such components for use with the Global Positioning System (GPS), i.e., the space-based satellite navigation system that provides location and time information in all weather conditions, anywhere on or near the Earth. In use, the GPS receiver 148 and GPS antenna 150 gather location and movement information, including latitude and longitude, elevation/altitude, and speed and direction of movement. The GPS receiver 148 also provides information on the accuracy of the GPS data, with respect to the number of available satellites and a variable called horizontal dilution of precision (HDOP). which is an integer ranging from 1-50 that indicates the quality of the angles used in the GPS triangulation calculation, which in turn reflects the accuracy of the latitude, longitude, speed, and direction provided by the GPS receiver 148. AGPS (assisted GPS) is preferably included so as to ensure the fastest possible fix time. AGPS allows the GPS receiver 148 to collect satellite acquisition information from the cellular network, which enables the GPS receiver 148 to decipher available GPS signals much faster. AGPS also permits the determination of location and movement information in extremely poor signal conditions (i.e. stormy weather or within buildings).

The accelerometer 152 is for detecting and measuring movement. The temperature sensor 154 is for detecting unsafe charging temperatures. The microphone 156 is for capturing sound in the vicinity of the bait package 112 (which may include conversations between persons involved in the theft of the bait package 112). The contact switch 158 is for detecting removal of the bait package 112 from a supporting or abutting surface, and is preferably a magnetic contact switch.

The charger connection 160 and battery connection 162 may be any of a variety of conventional connections, for example a standard 5V mini-B USB port or direct solder.

The sound emitter 116 may be any conventional electrically driven device for generating one or a variety of sounds or tones, for example, a buzzer that emits a loud intermittent beeping sound. The beeping intervals and sound volume are controlled by the tracking module microprocessor 160, and may be triggered either automatically in response to defined triggering conditions or on receipt of instructions. It is understood that the sound emitter 116 will be useful for locating the bait package 112 in situations in which the precise location of the bait package 112 cannot be determined based on the available GPS resolution, for example within an interior space (e.g., within a house or apartment). It is understood that the option of instructing the sound emitter 116 to emit a loud sound or tone may aid law enforcement authorities in obtaining a warrant to search a premises suspected of containing stolen goods.

The battery 118 is a conventional rechargeable battery suitable for relatively small electronics devices (e.g., handheld devices) and supplies power to the tracking module 114.

The induction receiver coil 120 is connected to the tracking module 114. The induction transmitter pad 122 is configured for cooperatively functioning with the induction receiver coil 120. When the induction transmitter pad 122 is powered (e.g., connected to a conventional power supply) and the induction receiver coil 120 is brought into sufficient proximity with the induction transmitter pad 122 (e.g., by placing the bait package 112 on or above the induction transmitter pad 122), the induction receiver coil 120 provides electrical power to the tracking module 114 sufficient to power the tracking module 114 and charge the battery 118. The induction transmitter pad 122 has an activation light 124 that illuminates when charging current is induced in the induction receiver coil 120.

Although perhaps not necessary for most applications, in some instances it may be desirable to charge or power other devices using the induction transmitter pad 122 or to use the induction receiver coil 120 with an induction pad not purpose built for use with the induction receiver coil 120. Therefore, it may be desirable to configure the induction receiver coil 120 and induction transmitter pad 122 to be compliant with an interface standard for inductive electrical transfer (for example the Qi standard developed by the Wireless Power Consortium).

Preferably, both the tracking module 114 and the induction system (i.e., the induction transmitter pad 122 and the induction receiver coil 120) have electrical regulating features. For example, the induction system may have a set maximum voltage and maximum current (e.g., 5V and 1 A), and the tracking module 114 may have internal charging circuitry having a lower maximum current threshold so as to provide ultimate charge limiting control. Preferably, when the battery 118 is fully charged and charging current approaches zero, the tracking module 114 is configured to break the charging connection between the battery 118 and the induction receiver coil 120.

In a public display situation, the induction transmitter pad 122 may be hidden, for example, the induction transmitter pad 122 may be installed in a counter top immediately below the desired location for the bait package 112. Alternatively, the induction transmitter pad 122 may be disguised, for example, the induction transmitter pad 122 may be integrated in a purpose-built stand for the bait package 112. Alternatively, the induction transmitter pad 122 may be covered, for example by a suitable fabric, or otherwise suitably concealed. Induction charging eliminates any visible external charging ports, which ensures the integrity of the “bait” idea by eliminating any external suggestions of electrical components in the bait package 112, while keeping the battery 118 fully charged without ongoing user involvement.

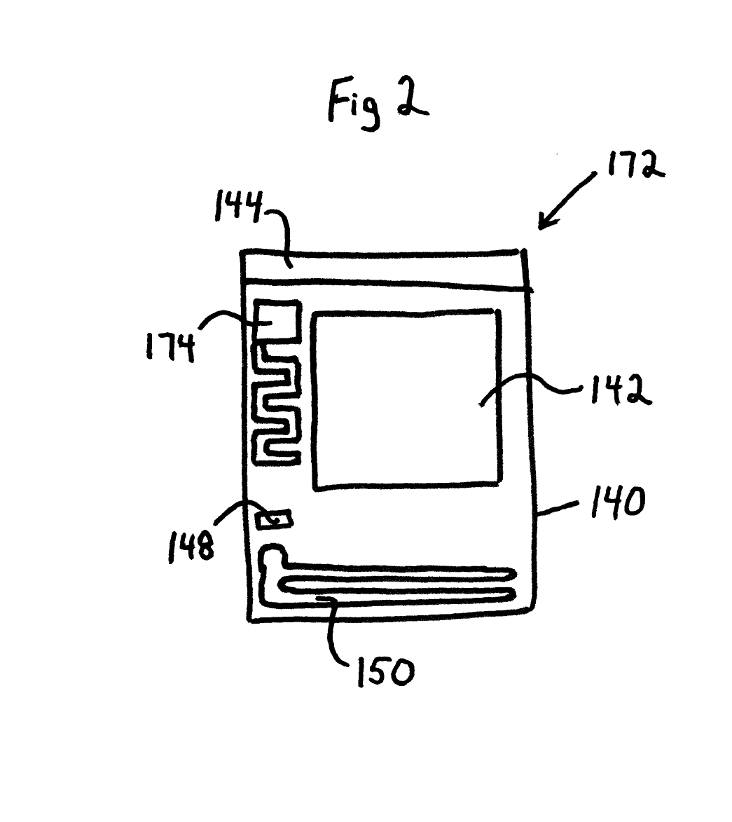

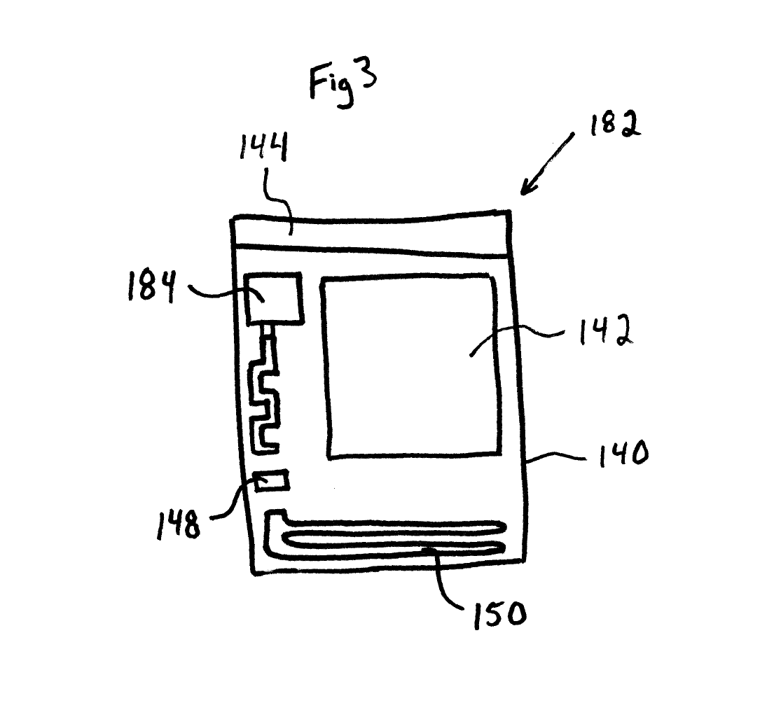

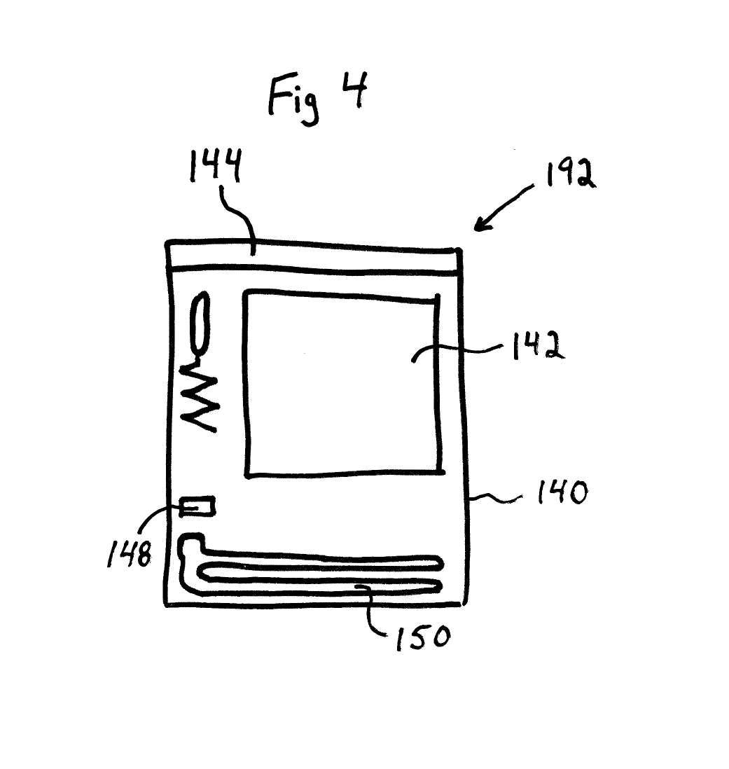

Alternative bait-package embodiments include: a Wi-Fi enabled bait package 170 having a Wi-Fi enabled tracking module 172 with a Wi-Fi transceiver 174, as shown in a simplified representation (i.e., a representation in which some of the components shared with tracking module 114 are not shown) in FIG. 2; a Bluetooth enabled bait package 180 having a Bluetooth enabled tracking module 182 with a Bluetooth transceiver 184, as shown in a simplified representation in FIG. 3; and an RFID enabled bait package 190 having an RFID enabled tracking module 192 with an RFID chip 194, as shown in a simplified representation in FIG. 4.

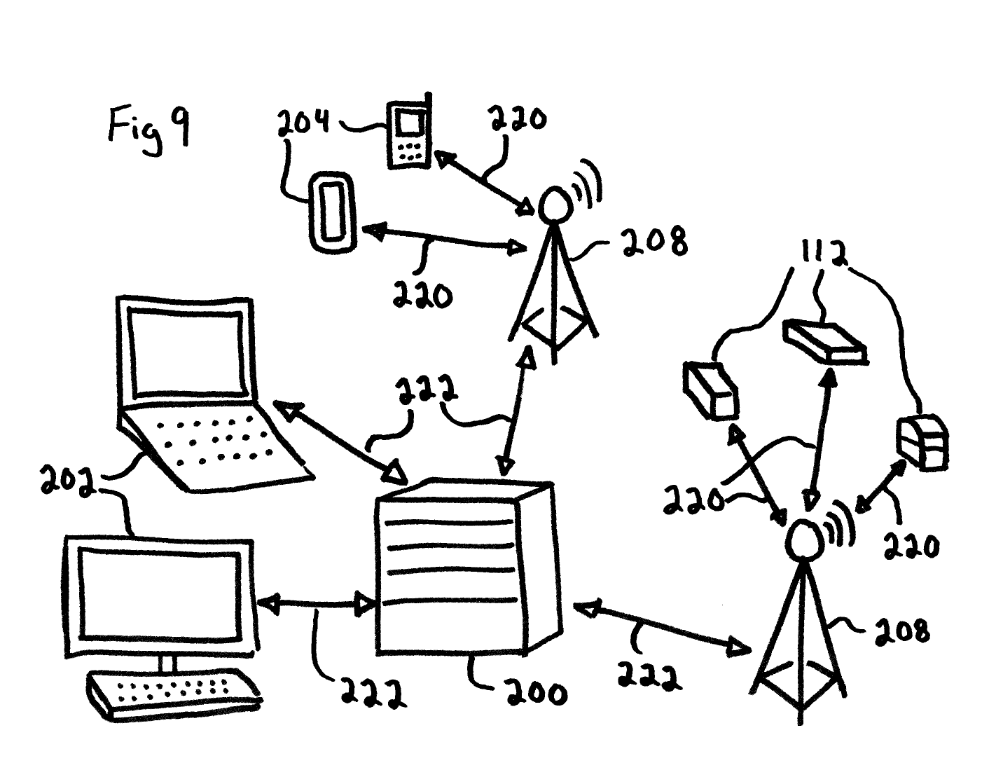

As shown in FIGS. 9-12, devices associated with bait package and system embodiments of the present invention include: a computer server 200, user computers 202 (e.g., laptops and personal computers); user handheld devices 204 (being devices enabled for cellular, Wi-Fi and Bluetooth, e.g., conventional smart phones), RFID transceivers 206, cellular network infrastructure 208 (indicated in the drawings by stylized “cell towers”); and a wireless network access point 210 (e.g., a wireless router). The communication pathways associated with bait package and system embodiments of the present invention include: cellular transmission 220; Internet pathways 220 (i.e., conventional land line channels of the Internet); Wi-Fi transmission 222; Bluetooth transmission 224; and RFID transmission 226.

FIG. 9 shows devices and communication pathways associated with bait package 112 (three are shown to illustrate that a plurality may be used concurrently), the devices being: computer server 200, user computer 202 (two are shown), user handheld device 204 (two are shown), and cellular network infrastructure 208. The associated communication pathways are: cellular transmission 220 (between the bait package 112 and cellular network infrastructure 208, and between the user handheld device 204 and cellular network infrastructure 208); and Internet pathways 222 (between cellular network infrastructure 208 and the computer server 200, and between user computer 202 and computer server 200)

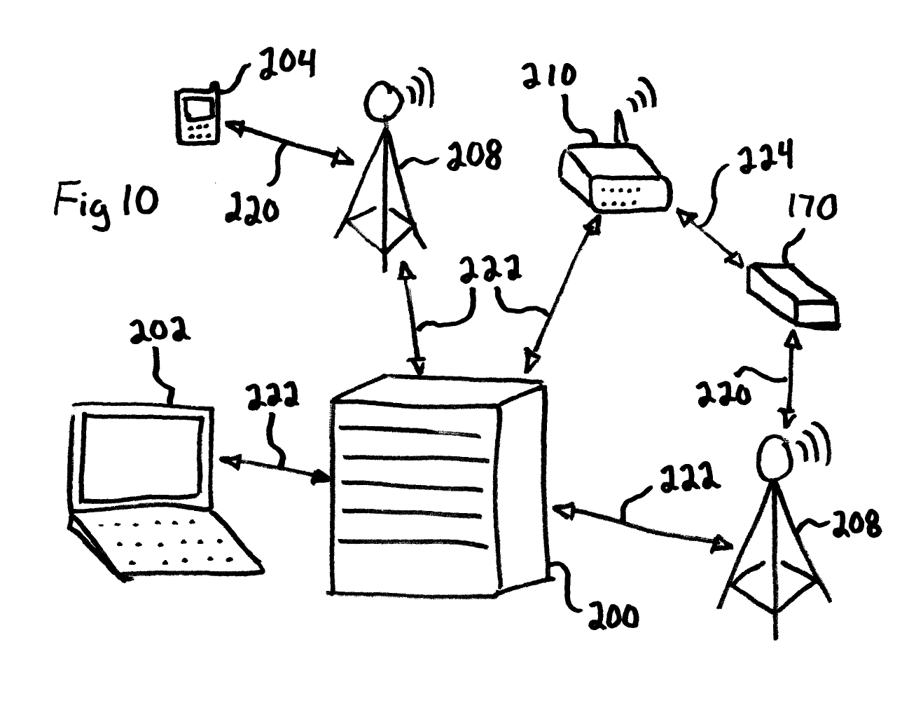

FIG. 10 shows devices and communication pathways associated with Wi-Fi enabled bait package 170, being (in addition to the devices and communication pathways associated with bait package 112), wireless network access point 210, Wi-Fi transmission 224 between Wi-Fi enabled bait package 170 and wireless network access point 210, and Internet pathways 222 between wireless network access point 210 and computer server 200. Thus Wi-Fi enabled bait package 170 is desirably configured to preferentially utilize Wi-Fi transmission 224 over cellular transmission 220, when a suitable wireless network access point 210 is available, thus reducing cellular system charges.

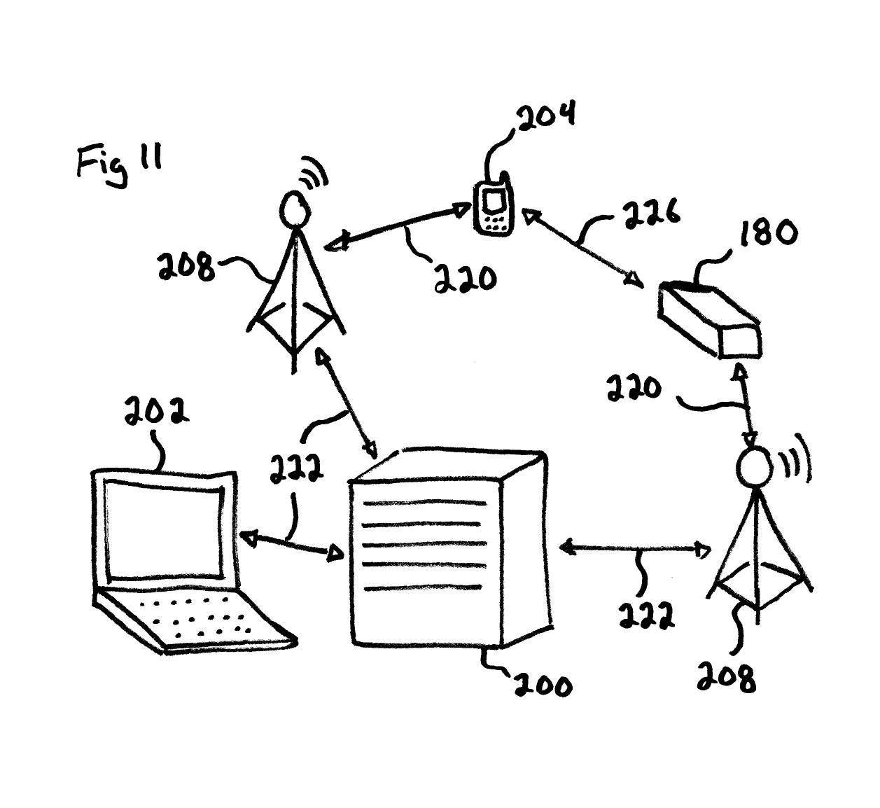

FIG. 11 shows devices and communication pathways associated with Bluetooth enabled bait package 180, being (in addition to the devices and communication pathways associated with bait package 112), Bluetooth transmission 226 between user handheld device 204 and Bluetooth enabled bait package 180. Bluetooth transmission 226 is reasonably reliable at distances of up to 100 meters. Thus, even with no cellular or Wi-Fi networks present, once the user is within roughly 100 meters of a Bluetooth enabled bait package 180, Bluetooth transmission 226 could be used to pinpoint the location of the Bluetooth enabled bait package 180, for example, with a user handheld device 204 installed with a suitable Bluetooth locator app.

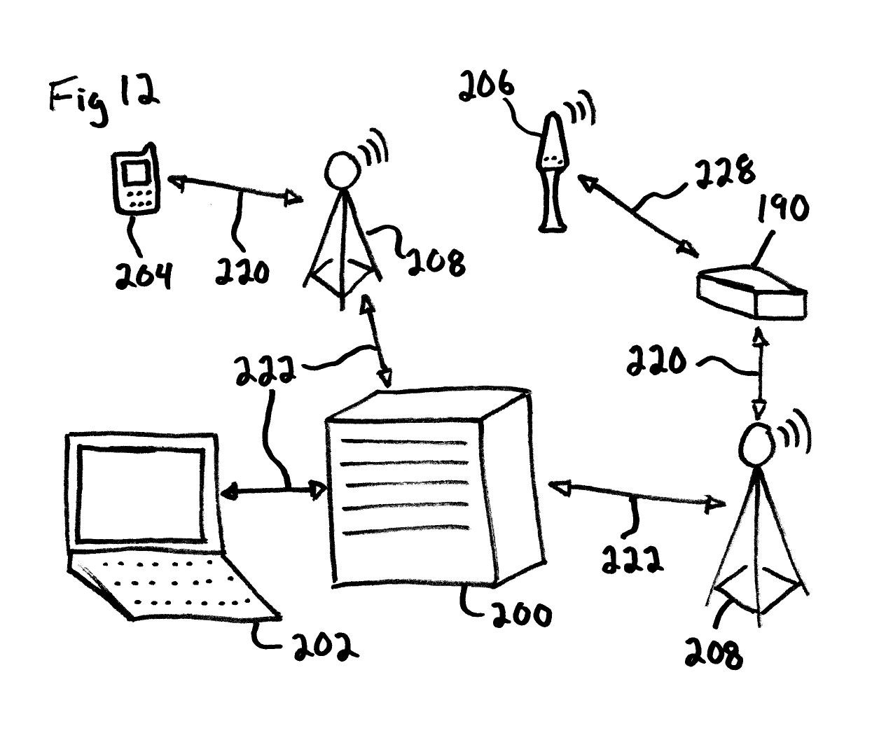

FIG. 12 shows devices and communication pathways associated with RFID enabled bait package 190, being (in addition to the devices and communication pathways associated with bait package 112), RFID transmission 228 between RFID transceiver 206 and RFID enabled bait package 190. The RFID transceiver 206 could be used to determine whether the RFID enabled bait package 190 has been removed from a contained area like a jewelry showcase or safe; or to determine whether the RFID enabled bait package 190 is present in a shipment without having to open the relevant container or package.

The user portal 300 is a web-based control and transmission facility provided by, and maintained on, the computer server 200. The user interacts (i.e., transmits information to and receives information from) the user portal 300 via a graphical user interface accessed with a user computer 202, user handheld device 204 or other suitable device for accessing online graphical user interfaces.

Users are initially defined on the user portal 300 and then one or more users is associated with each bait package 112. Each user can be assigned as either a primary user or emergency contact depending on their role. The user role and user phone number is transmitted to the relevant bait package 112 by the computer server 200 and the bait package 112 saves the information for later use when transmitting to cell phones as needed to send alarms and other information (e.g., low battery alerts).

Information transmitted between a bait package 112, and a user computer 202 or user handheld device 204 is encrypted (preferably, with Advanced Encryption Standard (AES) or another effective encryption standard) and is password protected, so as to protect sensitive information, including information pertaining to the location of the bait package.

The decryption password for a bait package 112 is kept private in that it is never transmitted via the computer server 200 or by Internet pathways 222. The user sets the password for a bait package 112 by cellular transmission 220 of an SMS message containing a personalized password directly to the bait package 112. That is, the user merely “texts” the password from the user's user handheld device 204 directly to the bait package 112. The tracking module 114 enters the password into the PBKDF2 (Password-Based Key Derivation Function 2) algorithm to generate a unique 32 bit hexadecimal key. The tracking module 114 then uses this key to encrypt all location data prior to transmission to the computer server 200. A randomly generated integer is included in every encrypted string to ensure a large variance in sequential messages even if the location data is exactly the same.

A user must enter the unique password for a bait package 112 into the user's web browser in order to decrypt the status information about that bait package 112. The decryption occurs at the browser level to ensure a password never enters the computer server 200. Thus, all sensitive data regarding the location and activity of a bait package 112 is AES encrypted from when it is sent from the bait package 112 until it is decrypted by the user on an internet browser. This protects the information while it is sent through the cellular networks, stored on host servers, and eventually sent through the internet to the user computer 202 or user handheld device 204. If any data is intercepted during transmission, or if the computer server 200 is hacked and information stolen, it will be difficult or impossible to decrypt the information. This greatly reduces the ability of any unauthorized sources to track and monitor the movements of high-valued goods with the intent to conduct an ambush.

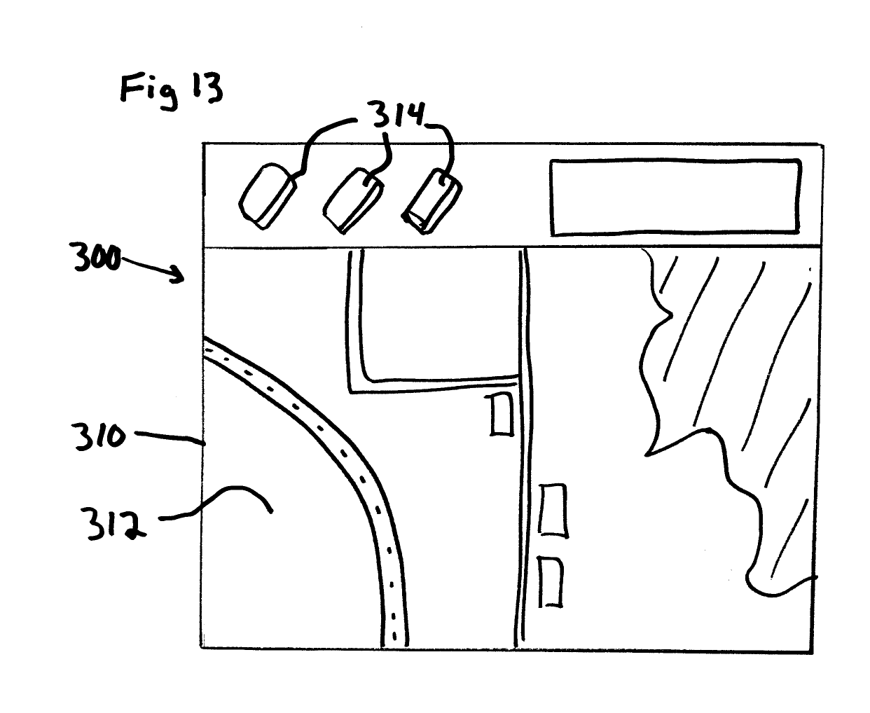

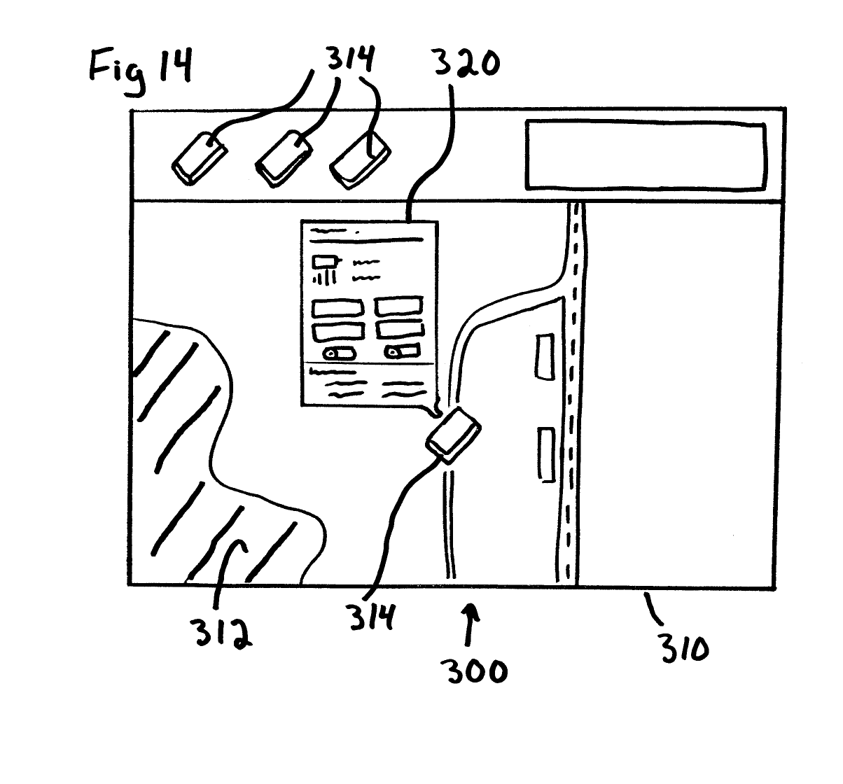

Once a user has entered the requisite password or passwords, the user gains access to the secure section of the user portal 300, which includes the following web pages, images, drop-down displays, icons, button and indicators. The initial web page that opens on user access is the tracking page 310 (represented in FIG. 13, which contains, among other things, a map image 312 and bait package icons 314. Activating a bait package icon 314 (i.e., by “clicking” on it), causes a corresponding bait package icon 314 to be displayed on the map image 312 at the most recently received geographic location of the relevant bait package 112, along with a dashboard 320 (represented in FIG. 14).

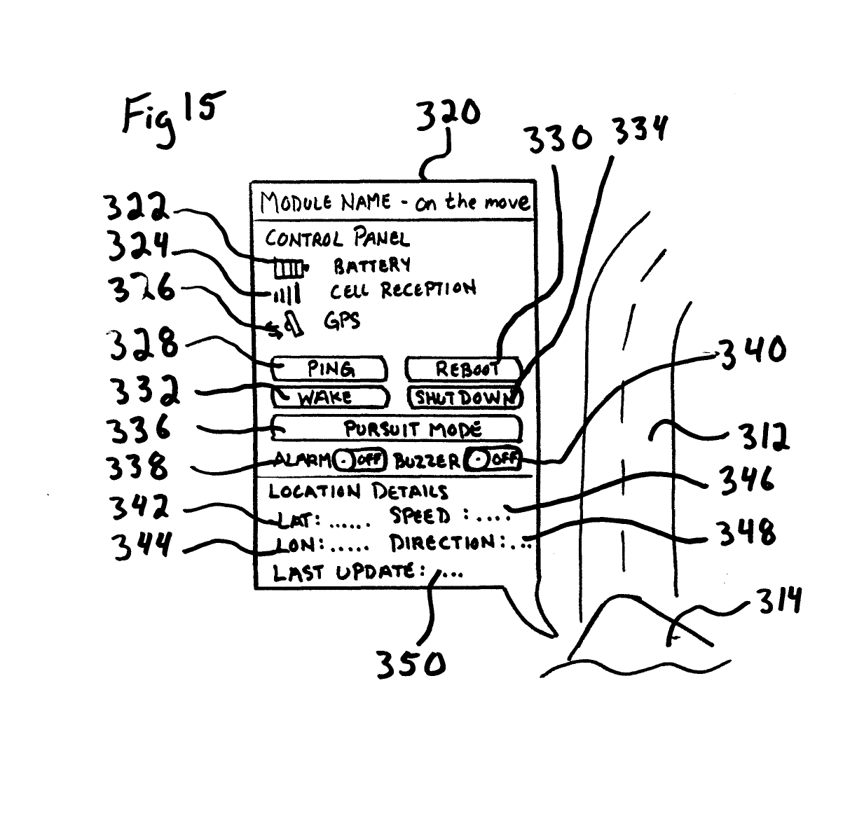

As indicated in FIG. 15, the dashboard 320 contains: a battery charge status indicator 322, a cell reception indicator 324, a GPS reception indicator 326, a Ping button 328, a Reboot button 330, a Wake button 332, a Shutdown button 334, a Pursuit Mode button 336, an Alarm toggle/button 338, a Buzzer toggle 340, and location detail displays, being latitude 342, longitude 344, speed of movement 346, direction of travel 348, and last update 350 (being the time when the location detail information was last updated).

Clicking the Ping button 328 causes the user portal 300 to update the status of the bait package 112. Clicking the Reboot button 330 causes the tracking module microprocessor 142 to reboot. Clicking the Shutdown button 334 shuts down the bait package 112; the bait package 112 is preferably configured such that it is necessary to place it sufficiently proximate to the induction transmitter pad 122 so as to induce detectable current in the induction receiver coil 120, in order to turn on the bait package 112.

Users are able to control significant aspects of the functioning of a bait package 112 via the user portal 300, for instance changing the tracking intervals, activating the sound emitter 116, and waking, sleeping and shutting down the tracking module 114.

When it is turned on (i.e, not shut down) a bait package 112 will usually be in one of two operational modes: (1) a low-powered “sleep” state, or (2) a tracking state. Whenever the bait package 112 is stationary, it will automatically go to the sleep state to save battery life. The bait package 112 will automatically switch from the sleep state fully-activated tracking state when it is disturbed or “on the move.” While moving, the bait package 112 tracks itself and reports its location to the computer server 200 at some pre-defined interval, typicall several minutes, for example 30 minutes. Once the bait package 112 becomes stationary again, it automatically returns to the sleep state within a few minutes. Clicking on the Wake button 332 causes the bait package 112 to switch from sleep state to the fully-activated tracking state. Regular tracking is reported only to the computer server 200, whereas alerts and alarms are sent by cellular transmission 220 to the user cell numbers of record.

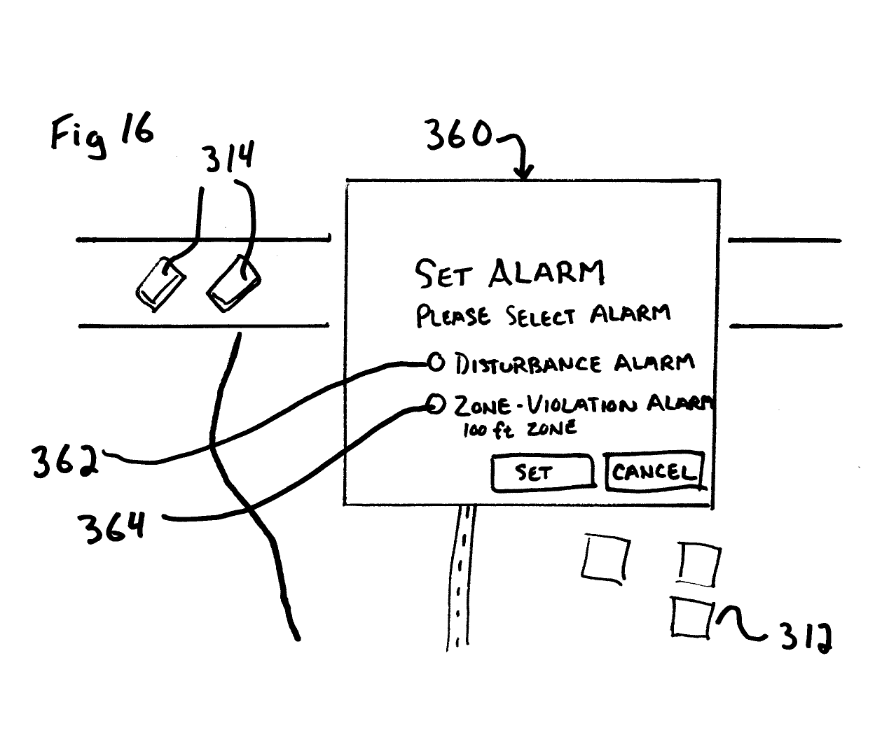

Two types of alarms can be set for each bait package 112. As indicated in FIG. 16, clicking on Alarm toggle/button 338 in a dashboard 320 causes a Set Alarm Box 360 to appear on the tracking page 310, permitting the user to select between a Disturbance Alarm 362 and a Zone-Violation Alarm 364. A disturbance alarm will be triggered if the accelerometer 152 detects movement. A zone violation alarm is triggered when the bait package 112 detects both movement and that its location is outside of a user-defined area. When either alarm is triggered, the bait package 112 sends, by cellular transmission 220, SMS messages to all associated users and emergency contacts notifying them of the violation, and reports the alarm to the computer server 200 as a “suspected theft” state. The disturbance alarm is useful for when goods are being stored and should not be tampered with—for example when a traveling salesperson leaves inventory in a vehicle and goes for lunch. The zone violation alarm is useful for when goods are being handled but should not leave a premises—for example when a jewelry store clerk is showing pieces of jewelry to prospective clients.

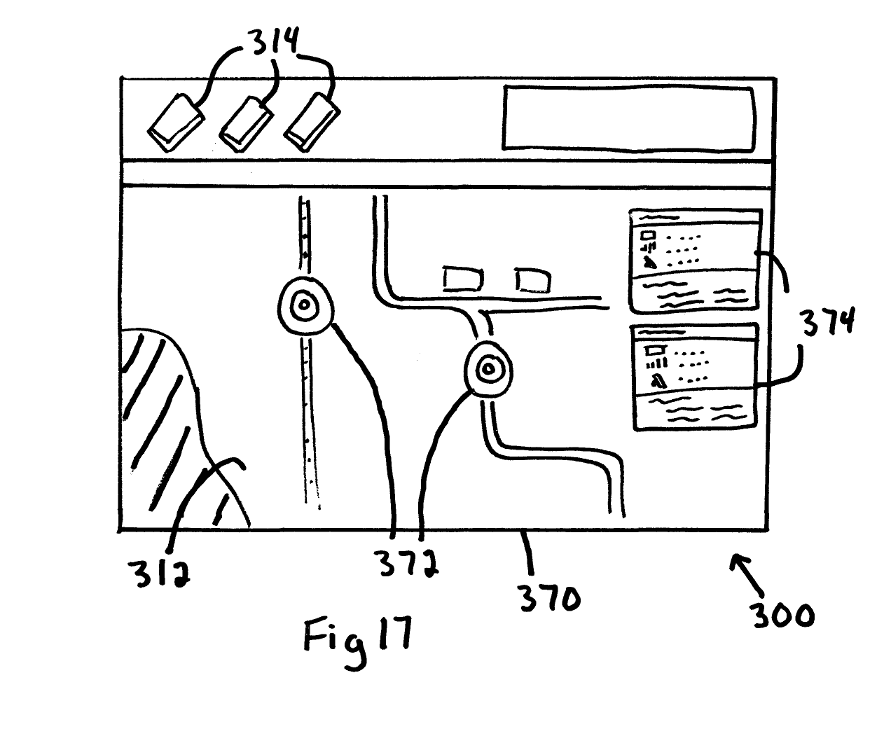

Clicking on the Pursuit Mode button 336 for a bait package 112: opens the pursuit mode page 370 (represented in FIG. 17), in which a tracking beacon 372 is associated with the bait package 112 and a simplified dashboard 374 is located at the side of the pursuit mode page 370 so as to not overly the map image 312: and causes the bait package 112 to update its location information on an essentially continuous basis, in that updates are transmitted approximately every 7 seconds.

Pursuit mode should be used only during emergency situations (i.e., suspected theft or other suspicious activity) because cellular use intensifies in this mode and extra data charges may apply. Thus, to reduce the likelihood of inadvertent or unnecessary activation of pursuit mode, the user portal 300 is preferably configured such that pursuit mode is available only for bait packages 112 with a status of “on the move” or “suspected theft”.

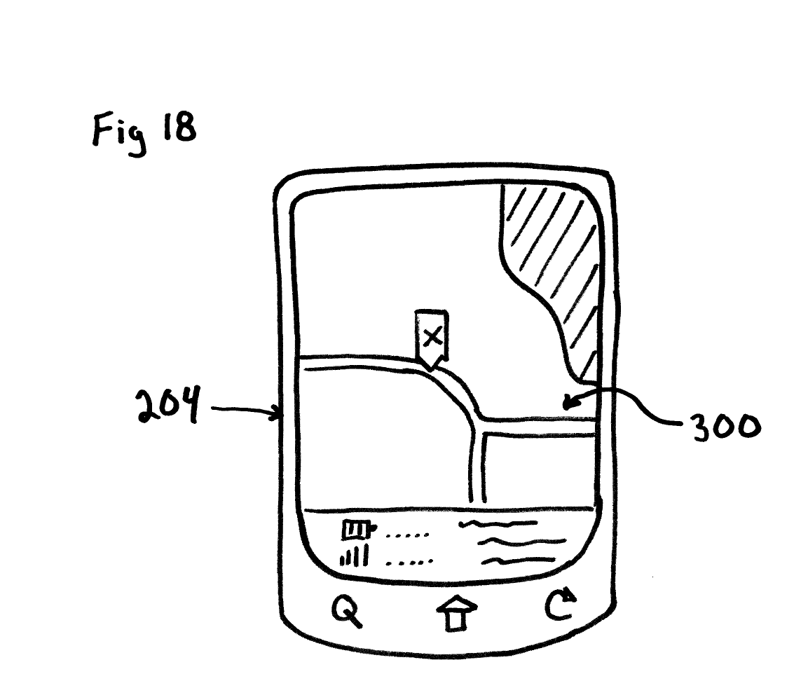

As indicated in FIG. 18, the user portal 300 may be accessed via a smart-phone app or mobile website, with a user handheld device 204, so as to enable users to move while monitoring goods in transit or tracking stolen goods.

Embodiments of the current invention may be used for both: mobile tracking and static monitoring. Both of these applications use the components and communication pathways described herein. The only difference is in the behaviour of the tracking modules 114, as determined by the program installed on each racking modules 114.

The mobile tracking application is used when high value goods are being transported. One or more bait packages 112 are included in the shipment of goods and packaged identically to the actual goods so as to make the bait packages 112 essentially indistinguishable from the goods. When the bait packages 112 are not in use they will be placed on induction transmitter pad 122 and will automatically enter into a low-powered sleep mode. Upon removal of the bait packages 112 from the transmitter pad 122, bait packages 112 will automatically wake up and begin tracking their location over long intervals. The user then includes the bait packages 112 in the shipment. The bait packages 112 will track throughout the transportation process and in the event of being stolen, can be viewable live via the user portal 300. Users of this application include travelling jewelry salespeople, gold buyers relocating their stock, refineries, jewelry manufacturers, shipping companies, and any other business where high valued goods need to be transported.

The monitoring application is used when high value goods are being stored and/or displayed in a specific location. The primary example of this application is the jewelry retail store. One or more bait packages 112 will be installed in packaging that matches the retailer's jewelry box collection. The type of packaging can be varied and will depend on what the user believes to be most desirable. A number of bait packages 112 may be randomly placed throughout the stock in the store showcases. The bait packages 112 may contain fake or actual items of jewelry (or other high-value items). The jewelry piece is fastened into the bait package 112 to ensure that it is not easily removed during a robbery. The induction transmitter pad 122 is preferably concealed beneath each bait package 112, for example, by being embedded in the counter or disguised as a standard showcase riser. Each bait package 112 will be in sleep mode on its induction transmitter pad 122 until removed or tampered with. In the event of a disturbance the bait device 112 will wake up and send alerts to the user in the form of SMS messages and/or emails and begin tracking. Ideally, a number of bait packages 112 will be stolen in the event of a theft, thus increasing the chances of product recovery. Other examples of monitoring applications include storing a bait package 112 in a safe or safety deposit box.

For individuals concerned about the security of their jewelry or other high-value items, a personal jewelry box may be retrofitted with an tracking module 114, battery 118 and induction receiver coil 120 (an optionally a sound emitter 116) and stored proximate an induction transmitter pad 122.

The monitoring application could involve incorporation of a call center which would be notified when a bait package 112 sends reports of events associated with an alarm. The call center would monitor the tracking status of the disturbed bait package 112 and if deemed necessary, contact the owner and/or law enforcement authorities.

The data transmission and monitoring application may include transmission of an alarm message directly to the user's location, for example to the alarm system of a store. If so configured, the alarm system may be activated by means of a cellular mobile connection (i.e. the bait package 112 would send data to an alarm company control network which would trigger the alarm system or perhaps send a message to a designated cell phone) or a localized RFID network (i.e. an in-store RFID transceiver 206 would detect the removal of the object and relay this information directly to the alarm system). It is understood that the average delay from time of disturbance to receipt of a SMS message on the user's phone would be about 5-10 seconds depending on network traffic. This level of service may not be necessary in the following scenarios: a) theft occurs while the owner is present, therefore he knows it occurred, or b) theft occurs when store is closed, thus a building alarm would be presumably be activated.

What is claimed is:

1. A tracking apparatus for use in monitoring the location of high-value items and recovering stolen items, the apparatus comprising:
a bait package containing;
a tracking module, including a microprocessor and computer memory, and enabled for connection with a cellular network and enabled for reception of Global Positioning System (GPS) information;
an induction receiver electrically connected to the tracking module; and
a battery electrically connected to the tracking module; and
an induction transmitter configured for inducing a charging current in the induction receiver, when the induction transmitter and induction receiver are sufficiently proximate one to the other;
wherein, in use, the bait package may be located so as to bring the induction transmitter and induction receiver into sufficient proximity to induce a charging current in the induction receiver, so as to maintain a desirable state of charge in the battery.

2. The apparatus of claim 1 wherein sufficient proximity to induce a charging current in the induction receiver includes a spaced apart relationship as between the bait package and the induction transmitter, whereby in use a material may be interposed between the bait package and the induction transmitter, so as to conceal or disguise the induction transmitter.

3. The apparatus of claim 1, wherein the enablement for reception of GPS information includes assisted GPS (AGPS) functionality whereby GPS satellite acquisition information may be obtained from a cellular network.

4. The apparatus of claim 1, wherein the tracking module is enabled for Wi-Fi communication or for Bluetooth communication, or for both.

5. The apparatus of claim 1, wherein the tracking module includes an RFID chip.

6. The apparatus of claim 1, further comprising a sound emitter powered by the battery and controlled by the microprocessor.

7. The apparatus of claim 1, further comprising a sensor component connected to the microprocessor, the sensor component comprising one or more of: an accelerometer for detecting and measuring movement; a temperature sensor for detecting unsafe charging temperatures; a microphone for capturing sound in the vicinity of the bait package; and a contact switch for indicating removal of the bait package from a surface.

8. The apparatus of claim 1, wherein the bait package has an appearance consistent with a display box for a high-value item.

9. The apparatus of claim 8, wherein the high-value item is selected from the group consisting of jewelry, time pieces, coins and precious metals.

10. A system for monitoring the location of high-value items and recovering stolen items, the system comprising:
at least one bait package according to claim 1; and
a computer server connected to the Internet and configured: for receiving information from and transmitting information to the bait package via a cellular network, and for providing a user with access, via a user computing device connected to the Internet, to information received from the bait package and for enabling the user to send instructions to the bait package.

11. The system of claim 10, wherein location information transmitted from the bait package is encrypted; the decryption password is set by the user by way of a message from a cellular network device to the bait package via a cellular network; and the decryption of information transmitted from the bait package occurs on the user computing device connected to the Internet, whereby the decryption password is not transmitted by, or stored on, the computer server.

12. The system of claim 10, wherein when a triggering event occurs the bait package sends an alarm message to at least one cell phone number provided by the user.

13. The system of claim 12, wherein the user may determine the triggering event.

14. The system of claim 13, wherein the user may select between two alternative triggering events, being any detected movement of the bait package, and removal of the bait package from within a defined area.

15. The system of claim 10, wherein the tracking module has three operational modes, being; a sleep mode in which the tracking module is dormant; a wake mode in which the tracking module transmits periodic information updates; and a pursuit mode in which the tracking module transmits functionally continuous information updates.

16. The system of claim 15, wherein the tracking module automatically switches from sleep mode to awake mode responsive to any detected movement of the bait package, and the user may instruct the tracking module to switch from sleep mode to awake mode, from awake mode to pursuit mode or sleep mode, and from pursuit mode to awake mode.

17. The system of claim 10, wherein the bait package further comprises a sound emitter powered by the battery and controlled by the microprocessor, and the user may cause the sound emitter to emit sound by an instruction sent via the user computing device connected to the Internet.

18. The system of claim 10, wherein the tracking module is enabled for Wi-Fi communication and is configured to preferentially utilize Wi-Fi communication over cellular network communication, when Wi-Fi service is available.

19. The system of claim 10, wherein the tracking module is enabled for Bluetooth communication and is configured for direct communication with a specific Bluetooth enabled device when instructed to do so by the user.
